(19) United States
(12) Patent Application Publication
(10) Pub. No.: US 2026/0269995 A1
(43) Pub. Date: Sep. 10, 2026

(54) TRANSMISSION CONFIGURATION INDICATOR TECHNIQUES

(71) Applicant: Google LLC, Mountain View, CA (US)

(72) Inventors: Yushu ZHANG, Beijing (CN); Jia-Hong LIOU, Taipei City (CN)

(21) Appl. No.: 19/156,881

(22) PCT Filed: Feb. 17, 2023
(86) PCT No.: PCT/CN2023/076948

§ 371 Date: Aug. 14, 2025

(51) Int. Cl. H04L 5/00

(52) U.S. Cl. CPC H04L 5/0044; H04L 5/0055

(57) ABSTRACT

This disclosure provides systems, devices, apparatus, and methods, including computer programs encoded on storage media, for TCI indication techniques. A UE may receive, on a PDSCH from a network entity, an activation indication that activates a subset of TCI states from a list of TCI states. The UE may transmit, to the network entity, an ACK for the PDSCH on a multi-slot PUSCH. The UE communicates with the network entity based on an action time associated with the activated subset of TCI states.

### TECHNICAL FIELD

The present disclosure relates generally to wireless communication, and more particularly, to transmission configuration indicator (TCI) techniques.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

For beam indication based on a unified transmission configuration indicator (TCI), the network entity can indicate a joint TCI to a user equipment (UE) to update the beam for both uplink and downlink channels. For separate TCI indications, the network entity can indicate a downlink TCI to the UE to update the beam for downlink channels and an uplink TCI to update the beam for uplink channels. The network entity can configure a TCI list for a bandwidth part (BWP) by RRC signaling and activate a subset of TCI states by a medium access control-control element (MAC-CE). The activated TCI states may correspond to different TCI-codepoints in downlink control information (DCI). If the activated TCI states correspond to more than one TCI-codepoint, the network entity can transmit the DCI to select the TCI state(s) corresponding to one TCI-codepoint for further communication.

For the TCI activation, the UE starts to apply the TCI states 3 ms after the UE transmits the physical uplink control channel (PUCCH) with the acknowledgement (ACK) for the physical downlink shared channel (PDSCH) with the MAC-CE. However, in some examples, the UE may transmit the ACK in PUSCH, but PUSCHs may be scheduled in multiple slots (e.g., multi-slot PUSCH). The UE transmits the PUSCH with the ACK in one slot (e.g., a first slot) of the multiple slots (e.g., multi-slot PUSCH). Hence, determining an action time for the TCI activation when the UE transmits the ACK for a multi-slot PUSCH may be of increased complexity.

For the TCI indication, the network entity can configure the action delay by RRC signaling. In some scenarios, such as for non-terrestrial networks (NTNs), a propagation delay could be large enough that the action delay may not be sufficient for downlink beam indication. However, the action delay could still be sufficient for uplink beam indication, which may result in mismatch between a beam of the network entity and a beam of the UE. The mismatch may be a result of the network entity applying a previous TCI for the PDSCH when the network entity has not yet received the ACK from the UE for a newly indicted TCI before the network entity transmits the PDSCH and the UE applying the newly indicated TCI for PDSCH reception.

The present disclosure addresses the above-noted and other deficiencies by determining the action time for the activated TCI states, using a second action delay for the TCI indication, and determining the applied TCI states and the transmission scheme when the number of indicated TCI states changes and the action time for the TCI indication is within a multi-slot PUSCH, PUCCH, or PDSCH transmission. Having the UE and the network entity support TCI indication under different scenarios, may result in improved scheduling flexibility to the network. For example, the network can schedule ACK/negative-ACK (NACK) feedback for TCI activation signaling by PUSCH, indicate the TCI by DCI in an NTN scenario, and update the TCI states for a channel with a multi-slot transmission scheme at any slot. Such techniques reduce system overhead (e.g., the network does not need to schedule a dedicated PUCCH to transmit the ACK/NACK feedback for TCI activation) and reduce TCI indication latency (e.g., the network can transmit the TCI indication signaling at any time and update the transmission scheme and the TCI states for a multi-slot channel at any time). The reduced TCI indication latency can also improve the system performance, since the network entity and the UE can apply improved beams with lower latency.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 illustrates an example for a joint transmission configuration indicator (TCI) operation for a single TRP (sTRP).

FIG. 3 illustrates an example for a TCI operation for multiple TRPs (mTRP).

FIG. 4 illustrates a diagram of a TCI operation with a physical uplink shared channel (PUSCH) to transmit an acknowledgment/negative-acknowledgment (ACK/NACK).

FIG. 5 illustrates a diagram of a TCI scenario with a large propagation delay.

FIGS. 6A-6B illustrate beam and transmission scheme selections.

FIG. 7 illustrates a signaling diagram for TCI activation with PUSCH based ACK/NACK feedback.

FIG. 8 illustrates a method of wireless communication at a UE for TCI activation with PUSCH based ACK/NACK feedback.

FIG. 9 illustrates a method of wireless communication at a network entity for TCI activation with PUSCH based ACK/NACK feedback.

FIG. 10 illustrates an example for TCI activation with the last symbol of the whole PUSCH as the starting point.

FIG. 11 illustrates an example for TCI activation with the last symbol of a PUSCH slot with ACK as the starting point.

FIG. 12 illustrates an example for the action time of a TCI activation update based on the transmission duration for the whole PUSCH.

FIG. 13 illustrates a signaling diagram for TCI indication with additional delay.

FIG. 14 illustrates a method of wireless communication at a UE for TCI activation with additional delay.

FIG. 15 illustrates a method of wireless communication at a network entity for TCI activation with additional delay.

FIG. 16 illustrates a signaling diagram for a TCI and transmission scheme determination.

FIG. 17 illustrates a method of wireless communication at a UE for the applied TCI and transmission scheme determination.

FIG. 18 illustrates a method of wireless communication at a network entity for the applied TCI and transmission scheme determination.

FIG. 19 illustrates a diagram where the multi-slot channel is based on an sTRP transmission scheme.

FIG. 20 illustrates a diagram where the multi-slot channel is based on an sTRP transmission scheme.

FIG. 21 illustrates a diagram where the multi-slot channel is based on a hybrid sTRP and mTRP transmission scheme.

FIG. 22 illustrates a diagram where transmission is stopped if the number of indicated TCI states change.

FIG. 23 illustrates a diagram where a second number of TCI states is less than a first number of TCI states.

FIG. 24 is a diagram illustrating a hardware implementation for an example UE apparatus.

FIG. 25 is a diagram illustrating a hardware implementation for one or more example network entities.

### DETAILED DESCRIPTION

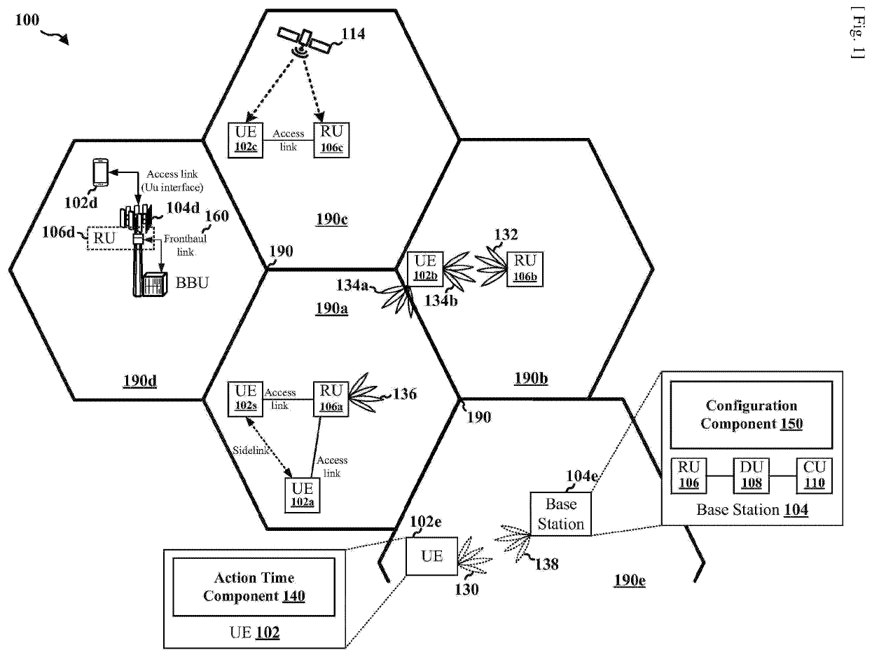

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include an action time component 140 configured to perform the aspects described herein. In certain aspects, any of the base stations 104 or a network entity of the base stations 104 may include a configuration component 150 configured to perform the aspects described herein. Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

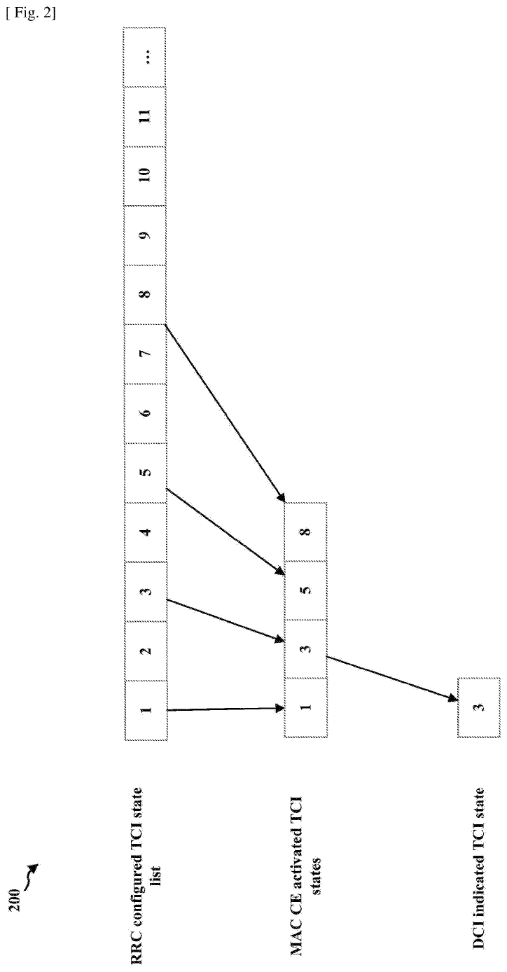

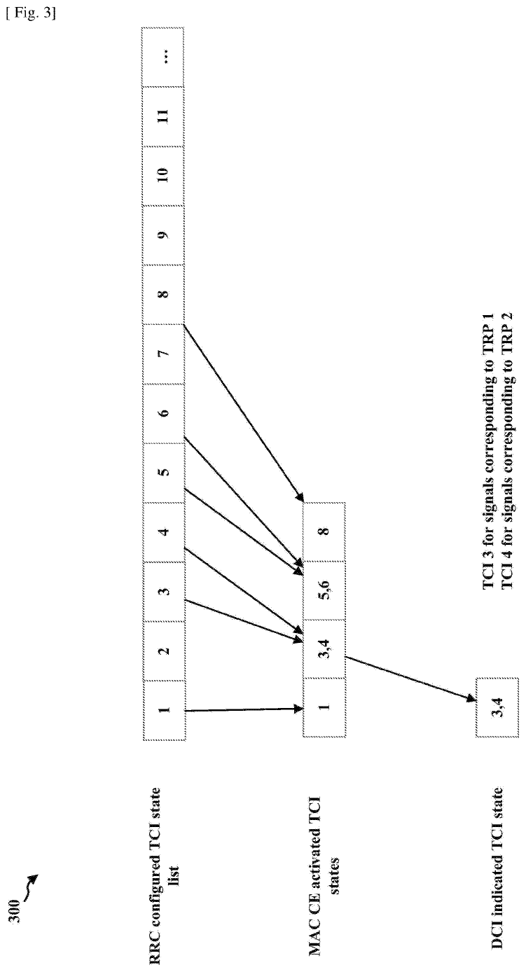

FIGS. 2-3 illustrate diagrams 200-300 of example transmission configuration indicator (TCI) operations. In particular, FIG. 2 illustrates an example for a joint TCI operation for a single TRP (sTRP), and FIG. 3 illustrates an example for a TCI operation for multiple TRPs (mTRP). In the diagram 200, the network entity only indicates one TCI state. In the diagram 300, the network can indicate more than one TCI state and each indicated TCI state can correspond to the signal for one TRP.

To increase the link budget, analog beamforming can be utilized at the network entity and UE side. The network entity and UE may maintain a plurality of beams. A good network-UE beam pair can greatly increase the link budget, thus providing significant coverage gain. The beam selection procedure is typically performed in two steps: 1) beam measurement and report, and 2) beam indication. The network entity can indicate the beam by indicating one of the TCI states in a TCI state list configured by radio resource control (RRC) signaling. The network can configure different quasi-co-location (QCL) source for different TCI states.

For the unified TCI based beam indication, the network entity can indicate a joint TCI to update the beam for both uplink and downlink channels or indicate a downlink TCI to update the beam for downlink channels and/or an uplink TCI to update the beam for uplink channels. The network entity can configure a TCI list for a bandwidth part (BWP) by RRC signaling and activate a subset of TCI states by medium access control-control element (MAC-CE). The activated TCI states correspond to different TCI-codepoints in downlink control information (DCI). If the activated TCI states correspond to more than one TCI-codepoint, the network entity can transmit a DCI to select the TCI state(s) corresponding to one TCI-codepoint for further communication.

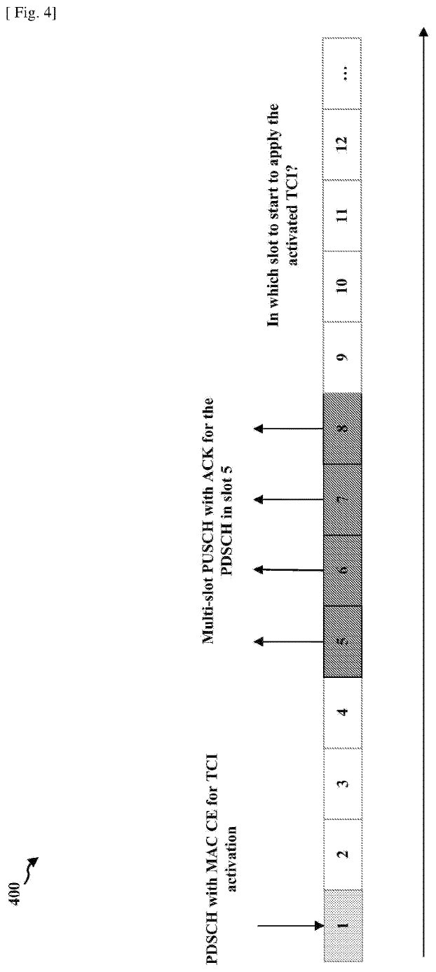

FIG. 4 illustrates a diagram 400 of a TCI operation with a physical uplink shared channel (PUSCH) to transmit an acknowledgment/negative-acknowledgment (ACK/NACK). For TCI activation, the UE starts to apply the TCI states 3 milliseconds (ms) after the UE transmits the physical uplink control channel (PUCCH) with the ACK of the physical downlink shared channel (PDSCH) with the MAC-CE. However, one possible issue is that the UE may transmit the ACK in PUSCH, and the UE may transmit the PUSCH in one or multiple slots, but the UE may only transmit the ACK in the first PUSCH slot as shown in the diagram 400, such that it may be difficult to determine the action time for the TCI activation when the UE transmits the ACK by PUSCH.

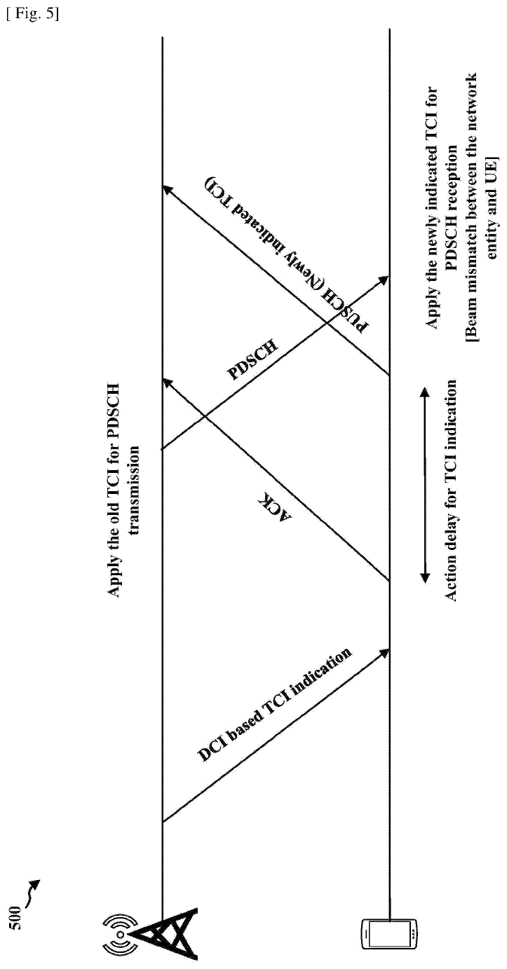

FIG. 5 illustrates a diagram 500 of a TCI scenario (e.g., non-terrestrial network (NTN)) with large propagation delay. For TCI indication, the network entity can configure the action delay by RRC signaling. However, in some scenarios, such as NTN scenarios, the propagation delay could be so large that the action delay could not be sufficient for downlink beam indication. But the action delay could still be sufficient for uplink beam indication. The diagram 500 illustrates an example of the potential action delay associated with NTN/large propagation delay scenarios. Providing the beam indication for such kind of scenarios may be of increased complexity.

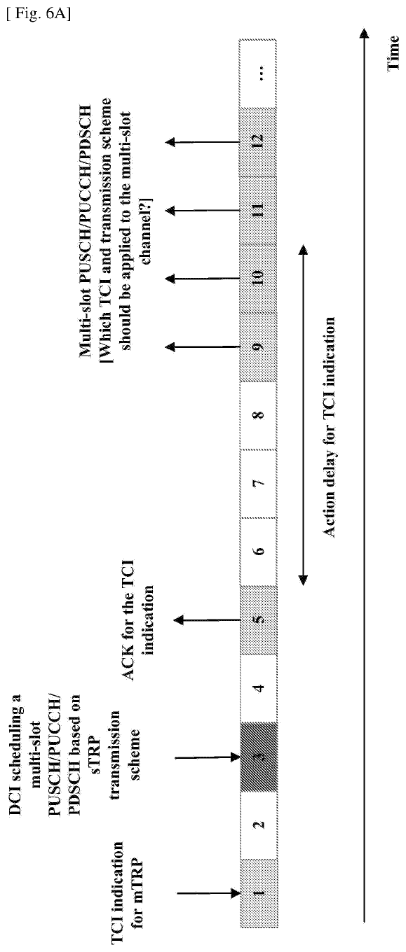

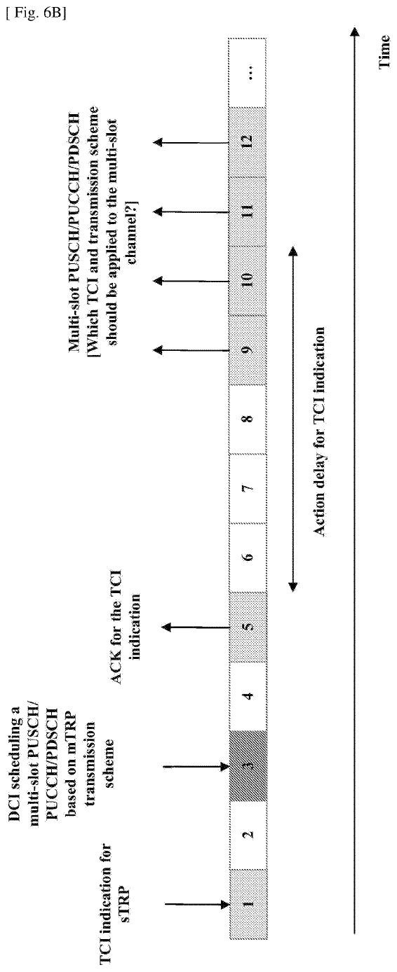

FIGS. 6A-6B illustrate beam and transmission scheme selections. In particular FIG. 6A illustrates a first scenario where the action time for the indicated TCI for mTRP is within a channel with sTRP transmission scheme in multi-slot. FIG. 6B illustrates a second scenario where the action time for the indicated TCI for sTRP is within a channel with mTRP transmission scheme in multi-slot. The action time for a TCI indication may be within the duration for a channel (e.g., PDSCH, PUSCH or PUCCH) with multi-slot transmission. The previously indicated TCI state may correspond to sTRP or mTRP operation while the latest indicated TCI state may correspond to mTRP or sTRP operation. Thus, it may be difficult to determine the beam and transmission scheme (e.g., sTRP or mTRP).

Increasing a robustness of TCI techniques may include: 1) TCI activation with PUSCH based ACK feedback, 2) TCI indication with regard to scenarios, such as NTN, with large propagation delay, and/or 3) TCI and transmission scheme selection when the action delay for TCI is within a channel with multi-slot transmission scheme. Such techniques support TCI indication with different scenarios, which can provide better scheduling flexibility to the network, e.g., the network can schedule the ACK/NACK feedback for a TCI activation signaling by PUSCH, and indicate the TCI by DCI in NTN scenario, and update the TCI states for a channel with multi-slot transmission scheme at any slot. Such techniques can also reduce the system overhead. For example, the network does not need to schedule a dedicated PUCCH to transmit the ACK/NACK for TCI activation. Such techniques can further reduce the TCI indication latency. For example, the network can transmit the TCI indication signaling at any time and update transmission scheme and beam for a multi-slot channel at any time. The reduced TCI indication latency can help improve the system performance, since the network entity and UE can apply a better beam with smaller latency.

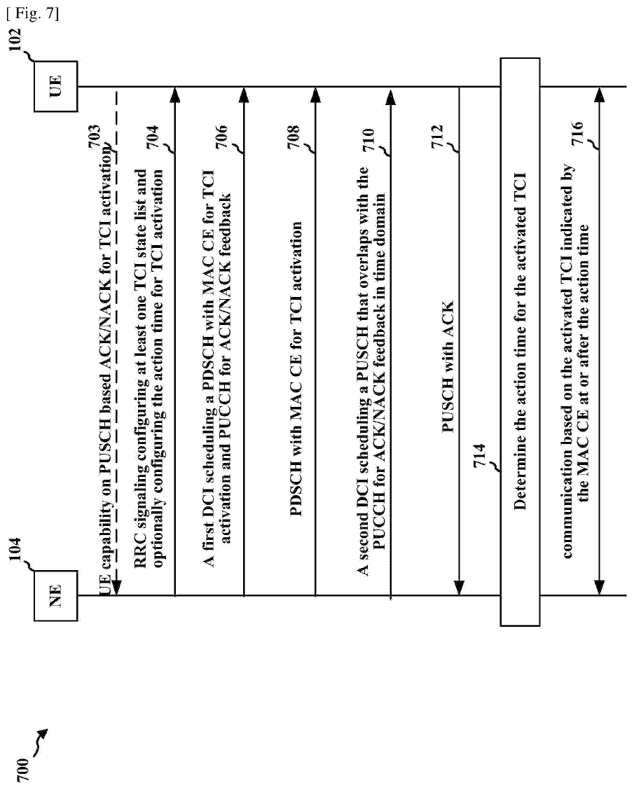

FIG. 7 illustrates a signaling diagram 700 for TCI activation with PUSCH based ACK/NACK feedback. The UE 102 may report 703 UE capabilities indicating that the UE 102 supports TCI activation with PUSCH based ACK/NACK. Based on the received 703 UE capabilities, the network entity 104 transmits 704 RRC signaling configuring at least one TCI state list, e.g., dl-OrJoint-TCIStateList and/or ul-TCI-StateList. The network entity 104 may optionally configure 704 the UE behavior on the action time counting for the TCI activation, e.g., the starting point to count the action time for TCI activation signaling. The network entity 104 transmits 706 a first DCI scheduling a PDSCH with MAC-CE based TCI activation and a PUCCH resource for ACK/NACK feedback. The network entity 104 also transmits 708 the scheduled PDSCH and transmits 710 a second DCI scheduling a PUSCH that overlaps with the PUCCH in time domain. The UE 102 transmits 712 the PUSCH with ACK/NACK. When the network entity 104 schedules the UE 102 to transmit the PUSCH with multiple slots, the UE 102 may transmit the ACK/NACK in the first slot. The network entity 104 and UE 102 may determine 714 the action time for the indicated or activated TCI states after the network entity 104 receives 712 the PUSCH and after the UE 102 transmits 712 the PUSCH, respectively. The network entity 104 and UE 102 may further communicate 716 based on the indicated activated TCI states after the action time of the indicated activated TCI states.

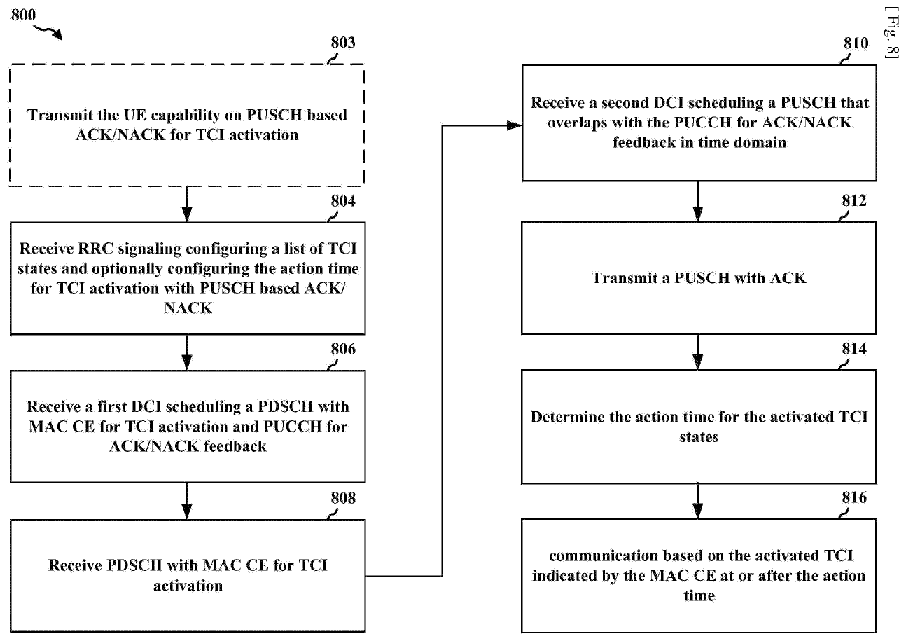

FIG. 8 illustrates a diagram 800 of a method of wireless communication at a UE. More specifically, FIG. 8 illustrates the UE behavior on TCI activation with PUSCH based ACK/NACK feedback.

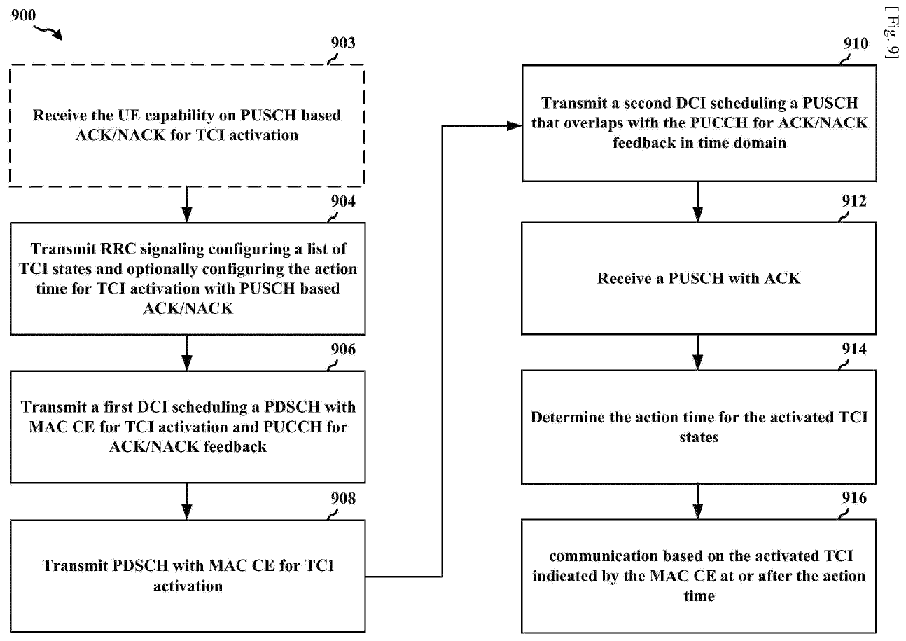

FIG. 9 illustrates a diagram 900 of a method of wireless communication at a network entity. More specifically, FIG. 9 illustrates the network entity behavior on TCI activation with PUSCH based ACK/NACK feedback.

As referred to herein, unless otherwise specified, RRC signaling from the network entity to the UE may indicate an RRC reconfiguration message, or a System Information Block (SIB), where the SIB can be an existing SIB (e.g., SIB1) or a new SIB (e.g., SIB J, where J is an integer above 21) transmitted by the network entity. RRC signaling from the network entity to the UE may indicate a UE forwarded RRC reconfiguration message. In examples, the network entity may receive the UE capability from a UE or from a core network (e.g., Access and Mobility Management Function (AMF)) or from another network entity.

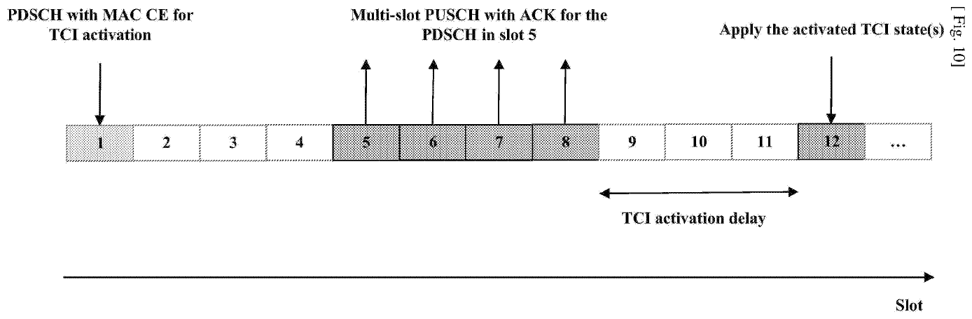

FIG. 10 illustrates an example for TCI activation with the last symbol of the whole PUSCH as the starting point. In a first implementation, the action time is counted with the last symbol of the PUSCH as the starting point. In FIG. 10, the action delay is 3 ms and the subcarrier spacing is 15 kHz. The starting point to count the action time of the TCI activation is the last symbol of the last slot with the PUSCH.

The UE and network entity determine the action time for the indicated active TCI states with the last symbol of the whole PUSCH transmission, which may be the last symbol of the last actual transmission occasion or nominal transmission occasion for the PUSCH as the starting point. The UE and network entity start to apply the indicated active TCI states after the X ms after the last symbol of the PUSCH with the ACK for the PDSCH with the MAC-CE based TCI activation, where X indicates the TCI activation delay, which can be predefined, e.g., 3 ms, or configured by the network entity via RRC signaling, which may be also determined based on the subcarrier spacing (SCS) of the PUSCH.

If the last PUSCH repetition among one or more PUSCH repetitions is dropped or not transmitted due to pre-emption (e.g., invalid uplink slot) or slot format, the last symbol would count on the last PUSCH repetition which is actually transmitted.

When the UE would transmit the last symbol of a PUCCH or PUSCH with hybrid automatic repeat request-acknowledgment (HARQ-ACK) information in slot n corresponding to the PDSCH carrying the activation command, the indicated mapping between TCI states and codepoints of the DCI field ‘Transmission Configuration Indication’ should be applied starting from the first slot that is after

$${slot}_{n} + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH or PUSCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the control resource set (CORESET) scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the demodulation reference signal (DM-RS) ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

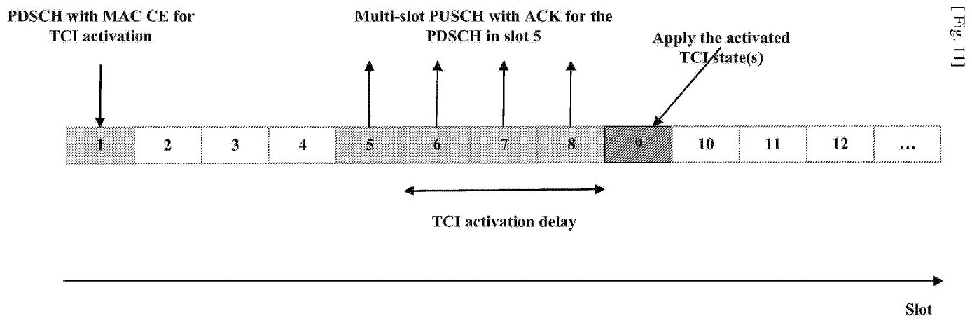

FIG. 11 illustrates an example for TCI activation with the last symbol of PUSCH slot with ACK as the starting point. In a second implementation, the action time is counted with the last symbol of the PUSCH slot with ACK as the starting point.

When the UE would transmit the last symbol of the transmission occasion of a PUCCH or PUSCH with HARQ-ACK information in slot n corresponding to the PDSCH carrying the activation command, the indicated mapping between TCI states and codepoints of the DCI field ‘Transmission Configuration Indication’ should be applied starting from the first slot that is after

$${slot}_{n} + 3 {N}_{slot}^{subframe , μ} + \frac{{2}^{μ}}{{2}^{{μ}_{{K}_{mac}}}} \cdot {k}_{mac}$$

where μ is the SCS configuration for the PUCCH or PUSCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQC L if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

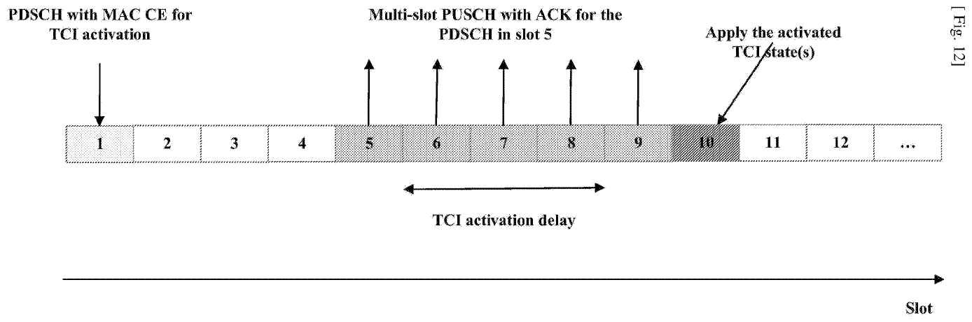

FIG. 12 illustrates an example for the action time of TCI activation update based on the transmission duration for the whole PUSCH. If the action time of the TCI activation is before the last slot of the PUSCH with ACK, the network entity and UE may determine the action time to be the next slot after the last slot of the whole PUSCH transmission occasion.

In a third implementation, an action time of a TCI activation counting scheme is configurable. The network entity configures the starting point to count the action time of TCI activation counting based on the first implementation or the second implementation by RRC signaling, MAC-CE, or DCI. The UE may further report UE capability indicating whether the UE supports the TCI activation time counting scheme.

The network entity may configure an RRC parameter indicating whether the UE should count the starting point of the action time of TCI activation based on the last symbol of the last slot (transmission occasion) of PUSCH with ACK or the last slot of the whole PUSCH. In other examples, the network entity configures whether the UE should count the starting point of the action time of TCI activation based on the last symbol of the last slot (transmission occasion) of PUSCH with ACK or the last slot of the whole PUSCH by a field in the MAC-CE for TCI activation. In further examples, the network entity configures whether the UE should count the starting point of the action time of TCI activation based on the last symbol of the last slot (transmission occasion) of PUSCH with ACK or the last slot of the whole PUSCH by a field in the first DCI scheduling the MAC-CE for TCI activation or a field in the second DCI scheduling the PUSCH.

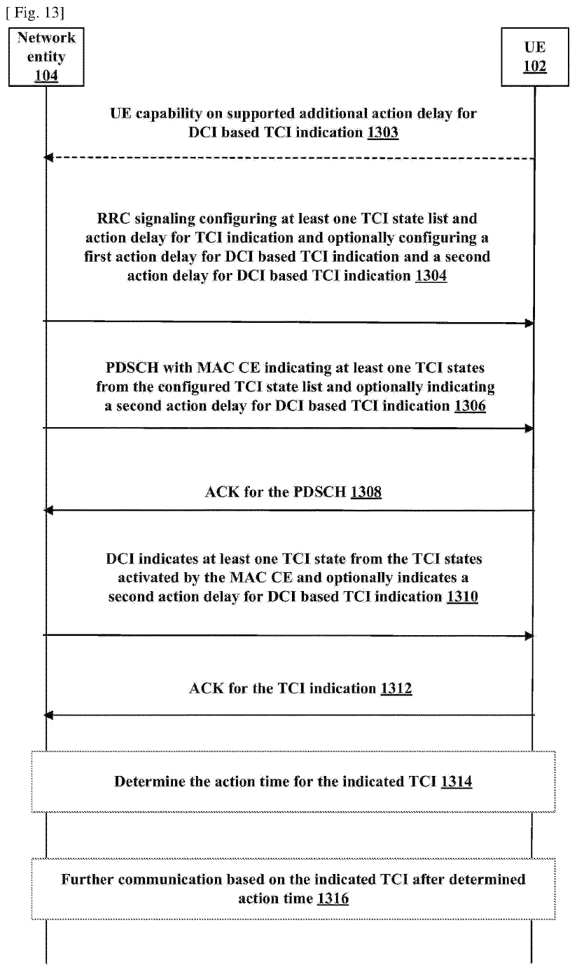

FIG. 13 illustrates a signaling diagram for TCI indication with additional delay. The UE may report the UE capability indicating the supported additional delay for the scenario with large propagation delay (e.g., NTN scenario). Based on the received UE capabilities, the network entity may transmit RRC signaling configuring at least a TCI state list, e.g., dl-OrJoint-TCIStateList and/or ul-TCI-StateList and optionally configuring a first action delay for the DCI based beam indication. The network entity may transmit a MAC-CE activating a subset of TCI states from the configured TCI state list. The network entity further transmits DCI indicating at least one TCI state from the activated TCI states. The network entity may configure or indicate a second action delay for DCI based TCI indication by the RRC signaling, MAC-CE, or DCI. The network entity and UE may determine the action time based on the first and second action delay and start to communicate with each other based on the indicated DCI after the action time.

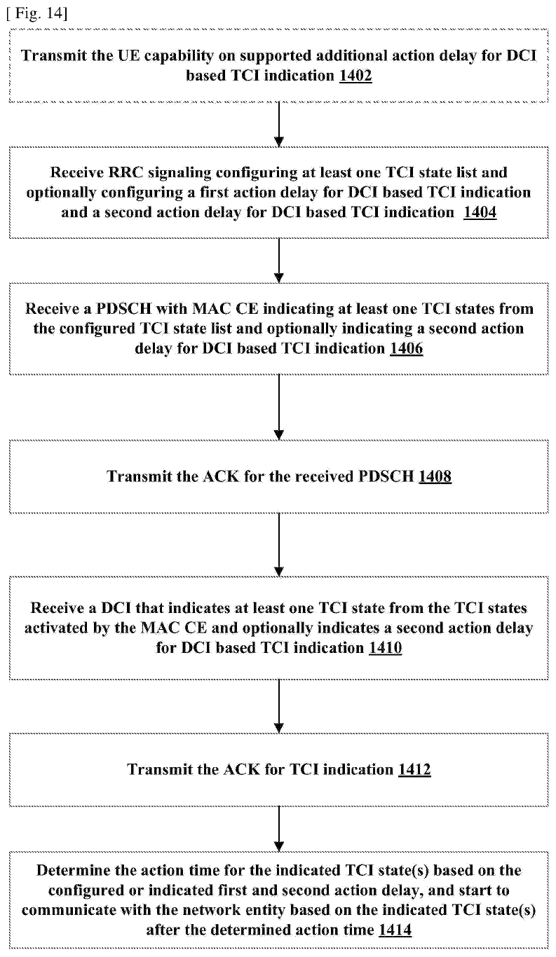

FIG. 14 illustrates a diagram of a method of wireless communication at a UE. More specifically, FIG. 14 illustrates the UE behavior on TCI activation with additional delay.

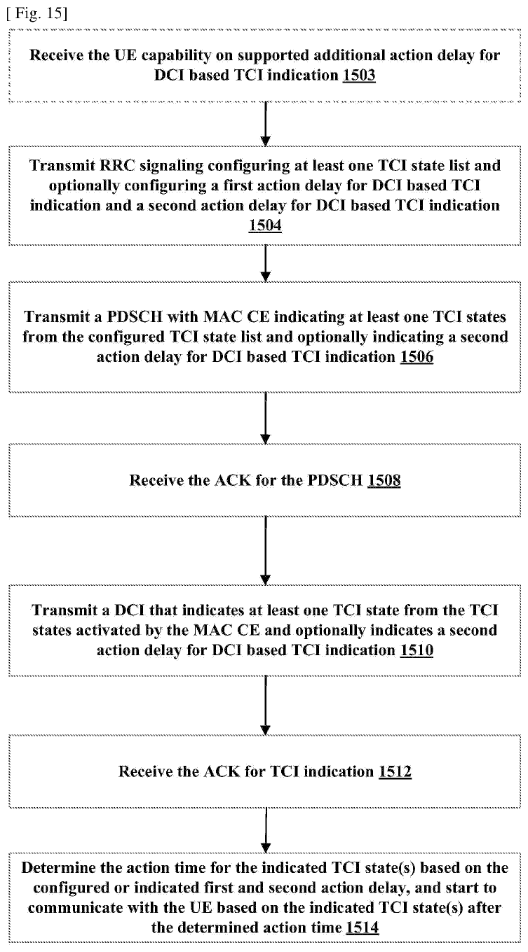

FIG. 15 illustrates a diagram 1500 of a method of wireless communication at a network entity. More specifically, FIG. 15 illustrates the network entity behavior on TCI activation with additional delay.

The UE may transmit the UE capability indicating at least one of: whether the UE supports configuring or indicating a second action delay for DCI based beam indication, the supported minimum value of the second action delay, or the supported maximum value of the second action delay. In a first example, the network entity configures the second action delay by RRC signaling. The second action delay may be configured in units of slots or symbols based on a reference subcarrier spacing, e.g., 15 kHz, or the configured subcarrier spacing. The second action delay may also be configured in units of millisecond, subframes, or frames.

For the serving cells configured in a serving cell list that share common TCI identifier (ID) update signaling, the network entity configures the same second action delay to make sure the action time for the common TCI ID update is the same for such serving cells. For the serving cells configured in a serving cell list that share the common TCI ID update signaling, the network entity and UE determine the second action delay configured for one of the serving cells in the serving cell list. The serving cell index may be predefined, e.g., the one with the lowest/highest serving cell index or configured by the network entity via RRC signaling.

In a second example, the network entity configures the second action delay by MAC-CE indication. The network entity configures the second action delay in the MAC-CE for TCI activation. The second action delay may be configured in units of slots or symbols based on a reference subcarrier spacing, e.g., 15 kHz, or the configured subcarrier spacing. The second action delay may also be configured in units of milliseconds, subframes, or frames. The network entity may indicate a common second action delay for all the activated TCI states, or the network entity may indicate separate second action delays for the activated TCI states corresponding to different TCI-codepoints. The network entity may indicate the separate second action delays for each activated TCI state.

For the serving cells configured in a serving cell list that share the common TCI ID update signaling, the network entity may indicate the same second action delay to make sure the action time for the common TCI ID update is the same for such serving cells. For the serving cells configured in a serving cell list that share the common TCI ID update signaling, the network entity and UE determine the second action delay indicated for one of the serving cells in the serving cell list. The serving cell index may be predefined, e.g., the one with the lowest/highest serving cell index, the one with the MAC-CE for TCI activation, or configured by the network entity via RRC signaling.

In a third example, the network entity configures the second action delay by DCI indication. The network entity configures the second action delay in the DCI for TCI indication. The second action delay may be configured in units of slots or symbols based on a reference subcarrier spacing, e.g., 15 kHz, or the configured subcarrier spacing. The second action delay may also be configured in units of milliseconds, subframes, or frames. The network entity may indicate the second action delay by a field, e.g., additional action delay for TCI indication, in the DCI. The network entity may also indicate whether to apply the second action delay by a field, e.g., a flag to apply additional action delay for TCI indication, in the DCI, where the value of the second action delay may be configured by RRC signaling as in the first example or by MAC-CE as in the second example.

For the serving cells configured in a serving cell list that share common TCI ID update signaling, the network entity indicates the same second action delay to make sure the action time for the common TCI ID update is the same for such serving cells. For the serving cells configured in a serving cell list that share the common TCI ID update signaling, the network entity and UE determine the second action delay indicated for one of the serving cells in the serving cell list. The serving cell index may be predefined, e.g., the one with the lowest/highest serving cell index, the one with the MAC-CE for TCI activation, the one with the DCI for TCI indication, or configured by the network entity via RRC signaling.

The action time may be determined based on a sum of the first and second action delay. The network entity and UE determine the action time for the DCI based TCI indication based on a total action delay from the first and second action delay. If the second action delay is not configured, the UE and network entity may determine the second action delay based on a predefined value, e.g., 0.

In some implementations, when the UE would transmit a PUCCH with HARQ-ACK information or a PUSCH with HARQ-ACK information corresponding to the DCI carrying the TCI State indication and without DL assignment, or corresponding to the PDSCH scheduled by the DCI carrying the TCI state indication, and if the indicated TCI dtate is different from the previously indicated TCI state, the indicated DLorJointTCIState or UL-TCIstate should be applied starting from the first slot that is at least

$$beamAppTime + \frac{{2}^{μ}}{{2}^{{μ}_{{K}_{mac}}}} \cdot {k}_{mac} {N}_{sym}^{slot}$$

symbols after the last symbol of the PUCCH or the PUSCH, where μ is the SCS configuration for the PUCCH or the PUSCH and μ_{K}_{_{mac}} is the subcarrier spacing configuration for k_{mac} with a value of 0 for frequency range 1, and k_{mac} is provided by Kmac or k_{mac}=0 if K-Mac is not provided, and

$${N}_{sym}^{slot}$$

is the number of symbols per slot. The first slot and the beamAppTime symbols are both determined on the active BWP with the smallest SCS among the active BWP(s) of the carrier(s) applying the beam indication.

In some other implementations, when the UE would transmit a PUCCH with HARQ-ACK information or a PUSCH with HARQ-ACK information corresponding to the DCI carrying the TCI State indication and without DL assignment, or corresponding to the PDSCH scheduled by the DCI carrying the TCI state indication, and if the indicated TCI dtate is different from the previously indicated TCI state, the indicated DLorJointTCIState or UL-TCIstate should be applied starting from the first slot that is at least

$$beamAppTime + \frac{{2}^{μ}}{{2}^{{μ}_{{K}_{mac}}}} \cdot {k}_{mac} {N}_{sym}^{slot}$$

symbols after the last symbol of the PUCCH or the PUSCH transmission occasion with HARQ-ACK information, where u is the SCS configuration for the PUCCH or the PUSCH and μ_{K}_{_{mac}} is the subcarrier spacing configuration for k_{mac} with a value of 0 for frequency range 1, and kₘₐₖ is provided by Kmac or k_{mac}=0 if K-Mac is not provided, and

$${N}_{sym}^{slot}$$

is the number of symbols per slot. The first slot and the beamAppTime symbols are both determined on the active BWP with the smallest SCS among the active BWP(s) of the carrier(s) applying the beam indication.

If the first action delay is not configured, the UE and network entity may determine the first action delay based on a predefined value, e.g., 0. When the UE would transmit a PUCCH with HARQ-ACK information or a PUSCH with HARQ-ACK information corresponding to the DCI carrying the TCI State indication and without DL assignment, or corresponding to the PDSCH scheduled by the DCI carrying the TCI State indication, and if the indicated TCI state is different from the previously indicated TCI state, the indicated DLorJointTCIState or UL-TCIstate should be applied starting from the first slot that is at least beamAppTime symbols after the last symbol of the PUCCH or the PUSCH. If the beamAppTime is not configured, the UE shall assume beamAppTime should be 0. The first slot and the beamAppTime symbols are both determined on the active BWP with the smallest SCS among the active BWP(s) of the carrier(s) applying the beam indication.

The action time may be further determined based on one of the first or second action delays. That is, the network entity and UE determine the action time for the DCI based TCI indication based on the action delay from one of the first or second action delays. If the second action delay is not configured but the first action delay is configured, the UE and network entity may determine the action time based on the first action delay. If the second action delay is configured but the first action delay is not configured, the UE and network entity may determine the action time based on the second action delay. If the first action delay and the second action delay are configured, the UE and network entity may determine the action time based on a predefined delay, e.g., 0. If the first action delay and the second action delay are configured, the network entity could further indicate or configure the UE with the action delay to apply. The network entity may also refrain from configuring both the first and second action delay. The UE and network entity may determine the action time based on the maximum or minimum delay from the first and second action delay.

The network entity may configure whether the UE will apply the action time based on the total delay from the first and second configured delay or the maximum/minimum delays from the first and second action delay by RRC signaling, MAC-CE, or DCI. The UE may report a UE capability indicating the supported action time determination scheme. The action delay may be determined based on the indicated TCI states. If the indicated TCI state is only a downlink TCI state, the UE applies the first action delay. Otherwise, the UE determines the action delay based on the first and second action delay as described above. The UE may apply the first action delay for the downlink TCI update and apply an action delay based on the first and second action delay, as described above, for an uplink TCI update.

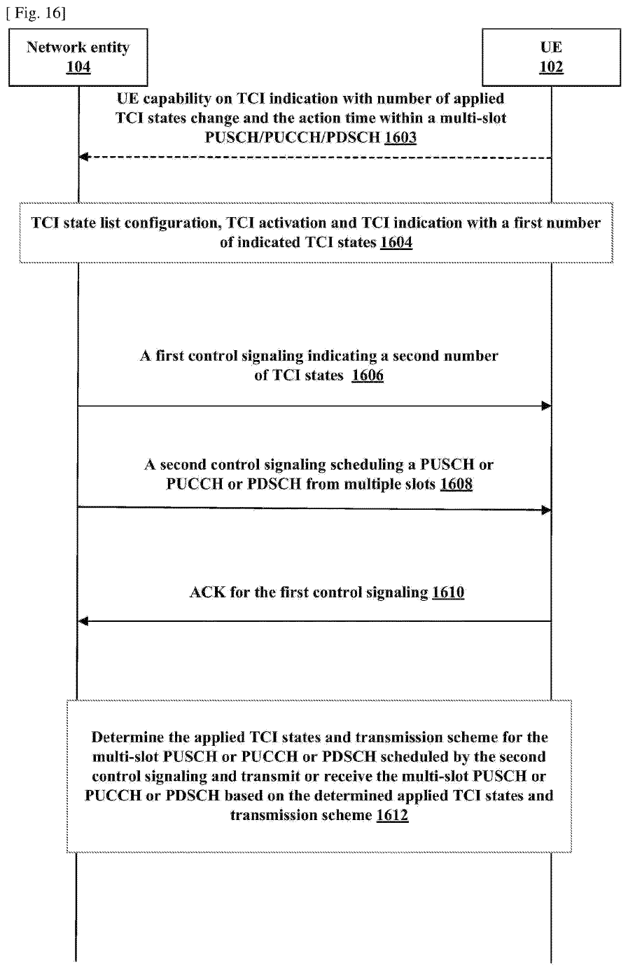

FIG. 16 illustrates a signaling diagram for a TCI and transmission scheme determination, such as when the number of indicated TCI states changes and the action time for the TCI indication is within a multi-slot PUSCH/PUCCH/PDSCH. The signaling procedure may also be applied when the action time for the TCI indication is before the multi-slot PUSCH/PUCCH/PDSCH and after the control signaling scheduling the multi-slot PUSCH/PUCCH/PDSCH. The UE may report the UE capability indicating whether the supports the scenarios illustrated in FIG. 6A and/or FIG. 6B. The UE may further report the supported UE behavior for the corresponding scenario. The network entity may indicate a first number of TCI states X1 by MAC-CE or DCI. The network entity may further indicate a second number of TCI states X2 by another MAC-CE or DCI (e.g., a first control signaling), where X2 is different from X1, and which may be applicable for different transmission scheme. The network entity may schedule a multi-slot PUSCH/PUCCH/PDSCH by second control signaling, e.g., a MAC-CE or DCI. The action time for the indicated second number of TCI states may be within the multi-slot PUSCH/PUCCH/PDSCH. The network entity and UE determine the applied TCI state(s) and transmission scheme for the multi-slot PUSCH/PUCCH/PDSCH and receive or transmit the multi-slot channel based on the determined TCI state(s) and transmission scheme.

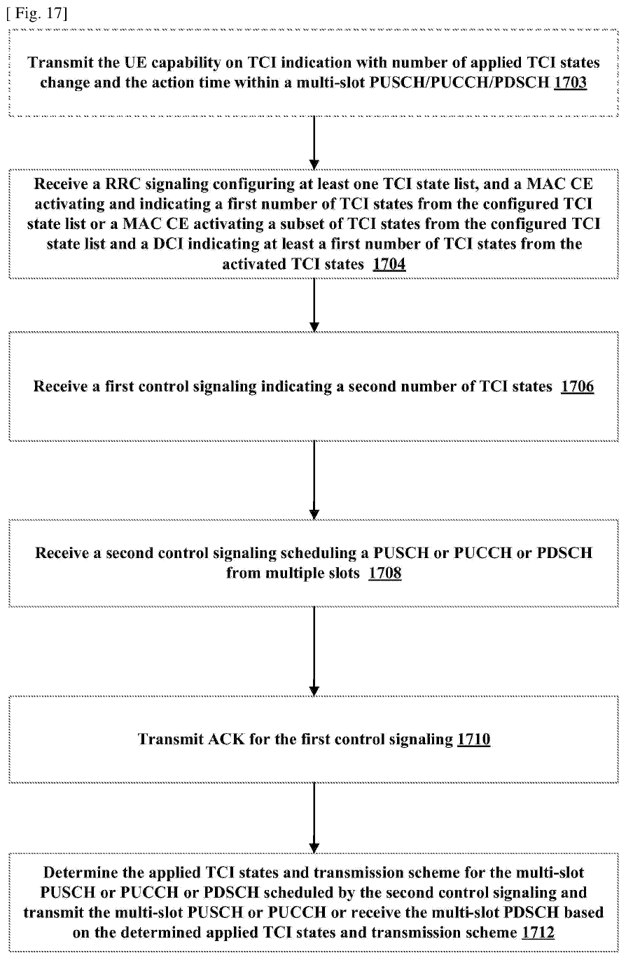

FIG. 17 illustrates a diagram of a method of wireless communication at a UE. More specifically, FIG. 17 illustrates the UE behavior on the applied TCI and transmission scheme determination.

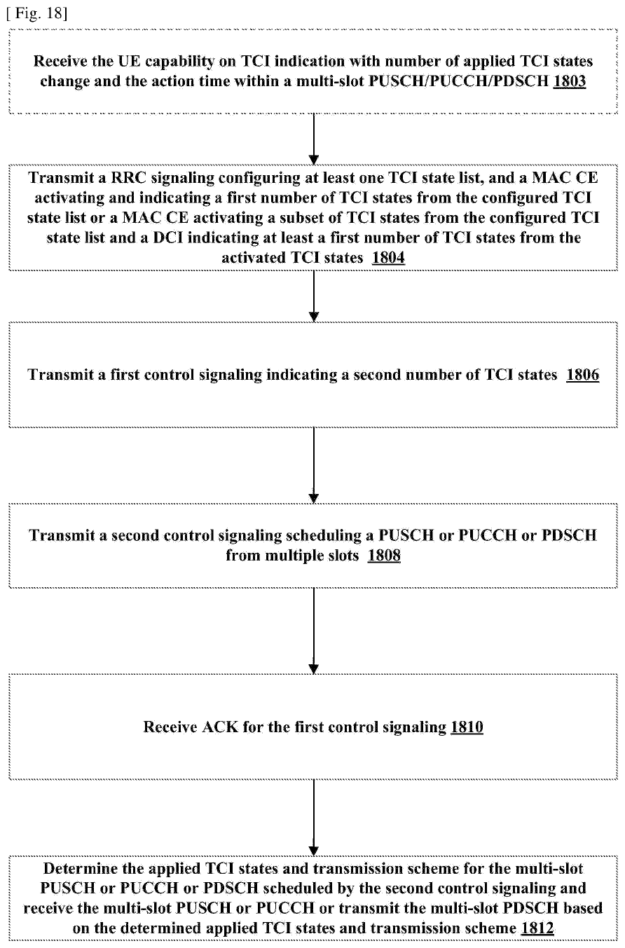

FIG. 18 illustrates a diagram of a method of wireless communication at a network entity. More specifically, FIG. 18 illustrates the network entity behavior on the applied TCI and transmission scheme determination.

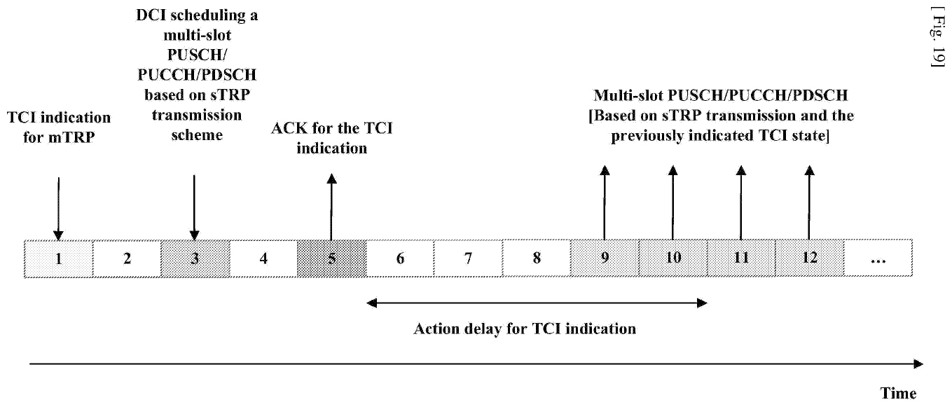

FIG. 19 illustrates a diagram where the multi-slot channel is always based on an sTRP transmission scheme with X1 indicated TCI states. The network entity and UE determines the applied TCI states and transmission scheme for the whole multi-slot PUSCH, PUCCH, or PDSCH based on the indicated TCI states in the first slot of the PUSCH, PUCCH, or PDSCH. Alternatively, the network entity and UE determine the applied TCI states and transmission scheme for the whole multi-slot PUSCH, PUCCH, or PDSCH based on the indicated TCI states in the first slot or the last slot of the second control signaling that triggering the multi-slot PUSCH, PUCCH, or PDSCH. The network entity may also refrain from indicating a second number of TCI states that require an mTRP operation with an action time in the middle of the multi-slot PUSCH, PUCCH, or PDSCH with the sTRP operation.

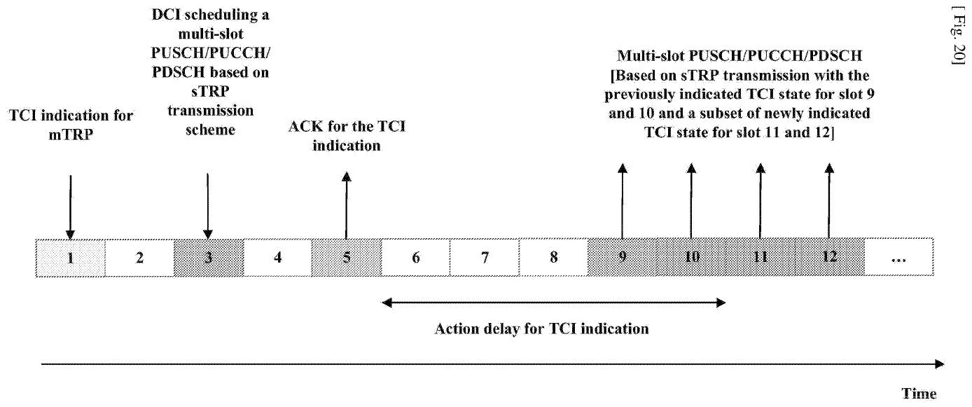

FIG. 20 illustrates a diagram where the multi-slot channel is based on an sTRP transmission scheme with X1 indicated TCI states and a subset of X2 indicated TCI states. The network entity and UE determines the transmission scheme for the whole multi-slot PUSCH, PUCCH, or PDSCH based on the indicated TCI states in the first slot of the PUSCH, PUCCH, or PDSCH. Alternatively, the network entity and UE determines the transmission scheme for the whole multi-slot PUSCH, PUCCH, or PDSCH based on the indicated TCI states in the first slot or the last slot of the second control signaling that triggering the multi-slot PUSCH or PUCCH or PDSCH.

The network entity and UE may determine the applied TCI states for the first subset of the multi-slot PUSCH, PUCCH, or PDSCH before the action time for the second indicated TCI states based on the first indicated TCI states, i.e., the first X1 indicated TCI states, and the remaining part of the multi-slot PUSCH, PUCCH, or PDSCH based on X1 TCI states from the second indicated X2 TCI states. For example, the second indicated X2 TCI states may be TCI #5 and TCI #6, such that the UE only applies TCI #5 for both slots 11 and 12.

The network entity and UE determines the subset of TCI states from the second indicated TCI states to be applied for the remaining part of the multi-slot channel based on the TCI indication order (e.g., the first indicated TCI state is selected). The network entity and UE may also determine the subset of TCI states from the second indicated TCI states to be applied for the remaining part of the multi-slot channel based on the TCI index (e.g., the TCI state with lowest/highest index is selected). The network entity indicates which TCI state should be selected for the remaining part of the multi-slot channel by DCI or MAC-CE. A DCI field in the DCI may indicate whether to select the first indicated TCI or the second indicated TCI for the multi-slot channel.

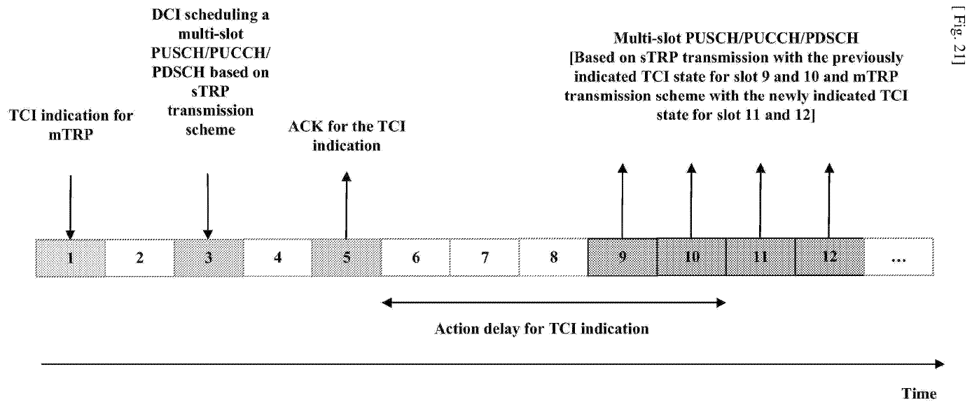

FIG. 21 illustrates a diagram where the multi-slot channel is based on a hybrid sTRP and mTRP transmission scheme with X1 indicated TCI states for sTRP and X2 indicated TCI states for mTRP. The network entity and UE determines the applied TCI states and transmission scheme for the first subset of the multi-slot PUSCH, PUCCH, or PDSCH before the action time for the second indicated TCI states based on the first indicated TCI states, i.e., the first X1 indicated TCI states, and the remaining part of the multi-slot PUSCH, PUCCH, or PDSCH based on the second indicated X2 TCI states.

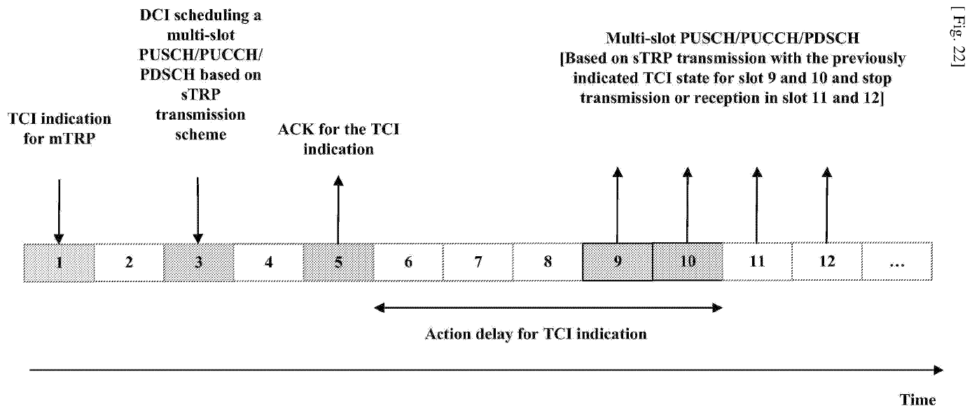

FIG. 22 illustrates a diagram where transmission is stopped if the number of indicated TCI states change. That is, the network entity and/or UE may stop the transmission or reception for the multi-slot channel if the number of indicated TCI states changes. The previously scheduled resource may or may not be available for another channel. The network entity may configure whether to apply a single transmission scheme or the hybrid transmission scheme by RRC signaling, MAC-CE, or DCI. The network entity may further configure whether to always apply the first indicated TCI states or the hybrid first and second TCI indicated states by RRC signaling, MAC-CE, or DCI. The UE may report the UE capability indicating whether the UE supports the hybrid transmission scheme for the multi-slot channel and/or hybrid indicated TCI states for the multi-slot channel.

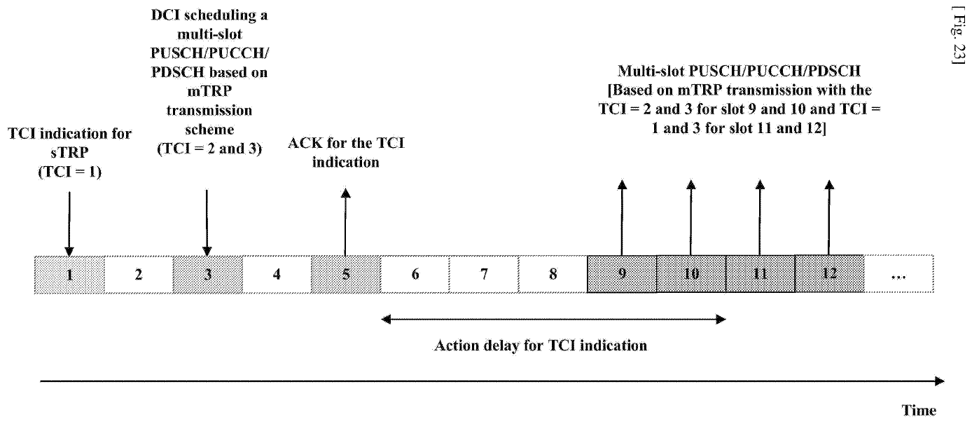

FIG. 23 illustrates a diagram where a second number of TCI states is less than a first number of TCI states. In first embodiment, the multi-slot channel is always based on an mTRP transmission scheme with X1 indicated TCI states. The network entity and UE determine the applied TCI states and transmission scheme for the whole multi-slot PUSCH, PUCCH, or PDSCH based on the indicated TCI states in the first slot of the PUSCH, PUCCH, or PDSCH. Alternatively, the network entity and UE determine the applied TCI states and transmission scheme for the whole multi-slot PUSCH, PUCCH, or PDSCH based on the indicated TCI states in the first slot or the last slot of the second control signaling that triggering the multi-slot PUSCH, PUCCH, or PDSCH.

In a second embodiment, the multi-slot channel is based on an mTRP transmission scheme with X1 indicated TCI states for a first part, and X2 and a subset of X1 indicated TCI states for a remaining part. The network entity and UE determine the transmission scheme for the whole multi-slot PUSCH, PUCCH, or PDSCH based on the indicated TCI states in the first slot of the PUSCH, PUCCH, or PDSCH. Alternatively, the network entity and UE determine the transmission scheme for the whole multi-slot PUSCH, PUCCH, or PDSCH based on the indicated TCI states in the first slot or the last slot of the second control signaling that triggering the multi-slot PUSCH, PUCCH, or PDSCH. The network entity and UE may determine the applied TCI states for the first subset of the multi-slot PUSCH, PUCCH, or PDSCH before the action time for the second indicated TCI states based on the first indicated TCI states, i.e., the first X1 indicated TCI states, and the remaining part of the multi-slot PUSCH, PUCCH, or PDSCH based on part of the first indicated X1 TCI states and the second indicated X2 TCI states. Thus, for the remaining part, the second indicated X2 TCI states may replace some of the first indicated X1 TCI states.

The network entity and UE may determine which TCI state(s) from the first indicated X1 TCI states are to be replaced based on the indication order. For example, the first or last indicated TCI state may be replaced by the second indicated TCI state. The network entity and UE may also determine which TCI state(s) from the first indicated X1 TCI states are to be replaced based on the TCI index. For example, the indicated TCI state with the lowest or highest index may be replaced by the second indicated TCI state. The network entity and UE may further determine which TCI state(s) from the first indicated X1 TCI states are to be replaced based on the associated TRP index. The network entity may configure the associated TRP index for each TCI state or reference signal of each TCI state, and the first indicated TCI index with the same TRP index as the second indicated TCI state is replaced. The network entity may also configure which TCI state(s) from the first indicated X1 TCI states are to be replaced by DCI or MAC-CE. For example, a field in the DCI scheduling the multi-slot channel or the DCI used to indicate the second TCI state may indicate which indicated TCI state to replace.

In a third embodiment, the multi-slot channel is based on a hybrid sTRP and mTRP transmission scheme with X1 indicated TCI states for mTRP and X2 indicated TCI states for sTRP. The network entity and UE determine the applied TCI states and transmission scheme for the first subset of the multi-slot PUSCH, PUCCH, or PDSCH before the action time for the second indicated TCI states based on the first indicated TCI states, i.e., the first X1 indicated TCI states, and the remaining part of the multi-slot PUSCH, PUCCH, or PDSCH based on the second indicated X2 TCI states.

In a fourth embodiment, transmission is stopped if the number of indicated TCI states changes. That is, the network entity and UE may stop the transmission or reception for the multi-slot channel if the number of indicated TCI states changes. The previously scheduled resource may or may not be available for another channel.

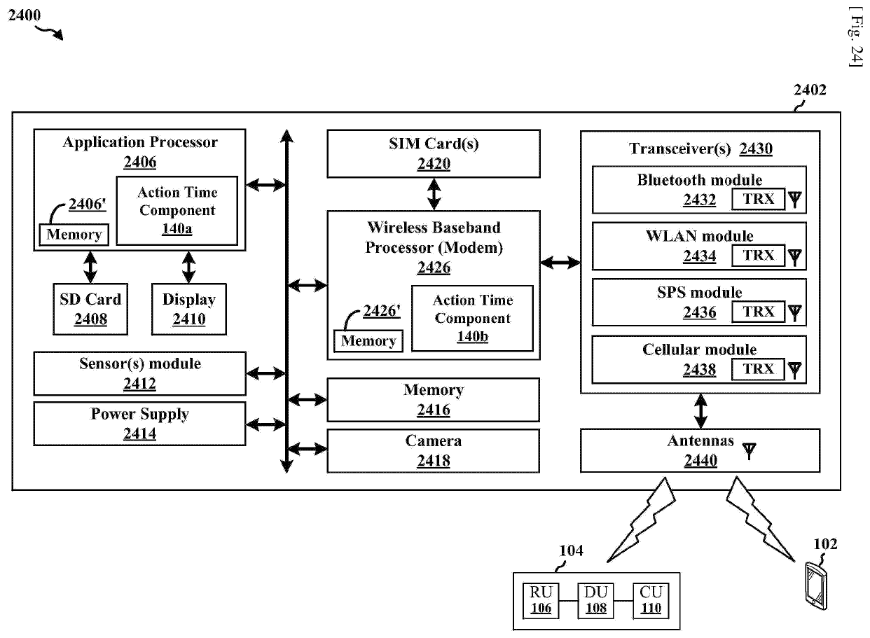

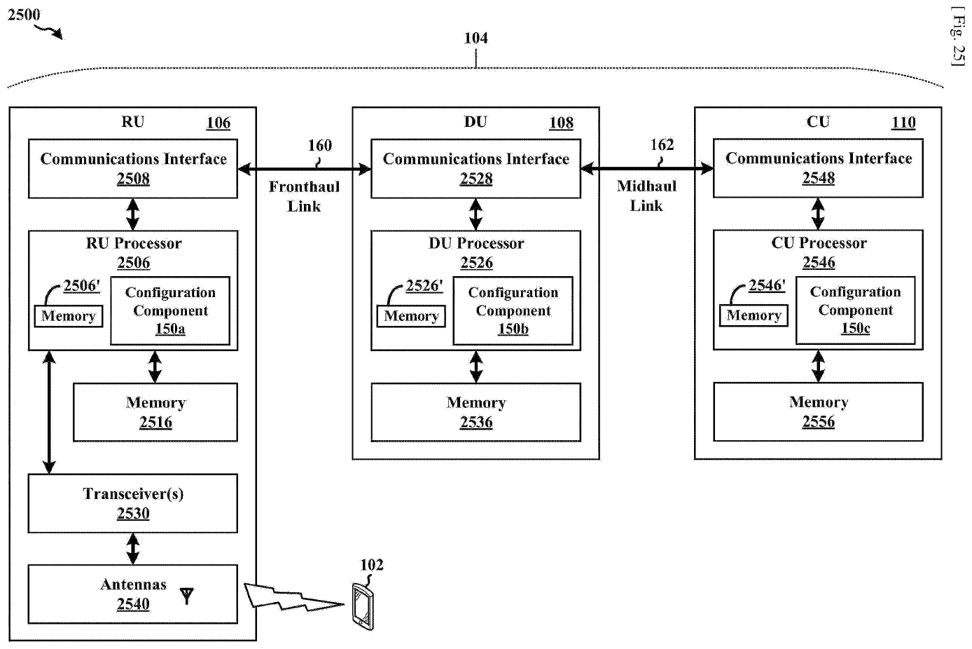

In a fifth embodiment, the applied TCI and transmission scheme determination is configurable. The network entity may configure whether to apply a single transmission scheme or a hybrid transmission scheme by RRC signaling, MAC-CE, or DCI. The network entity may further configure whether to always apply the first indicated TCI states or hybrid first and second TCI indicated states by RRC signaling, MAC-CE, or DCI. The UE may report the UE capability indicating whether the UE supports a hybrid transmission scheme for the multi-slot channel and/or hybrid indicated TCI states for the multi-slot channel. A UE apparatus 2402, as described in FIG. 24, may perform the method of the flowcharts illustrated in FIGS. 8, 14, and 17. The one or more network entities 104, as described in FIG. 25, may perform the method of the flowchart illustrated in FIGS. 9, 15, and 18.

FIG. 24 is a diagram 2400 illustrating an example of a hardware implementation for a UE apparatus 2402. The UE apparatus 2402 may be the UE 102, a component of the UE 102, or may implement UE functionality. The UE apparatus 2402 may include an application processor 2406, which may have on-chip memory 2406′. In examples, the application processor 2406 may be coupled to a secure digital (SD) card 2408 and/or a display 2410. The application processor 2406 may also be coupled to a sensor(s) module 2412, a power supply 2414, an additional module of memory 2416, a camera 2418, and/or other related components. For example, the sensor(s) module 2412 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 2402 may further include a wireless baseband processor 2426, which may be referred to as a modem. The wireless baseband processor 2426 may have on-chip memory 2426′. Along with, and similar to, the application processor 2406, the wireless baseband processor 2426 may also be coupled to the sensor(s) module 2412, the power supply 2414, the additional module of memory 2416, the camera 2418, and/or other related components. The wireless baseband processor 2426 may be additionally coupled to one or more subscriber identity module (SIM) card(s) 2420 and/or one or more transceivers 2430 (e.g., wireless RF transceivers).

Within the one or more transceivers 2430, the UE apparatus 2402 may include a Bluetooth module 2432, a WLAN module 2434, an SPS module 2436 (e.g., GNSS module), and/or a cellular module 2438. The Bluetooth module 2432, the WLAN module 2434, the SPS module 2436, and the cellular module 2438 may each include an on-chip transceiver (TRX), or in some cases, just a transmitter (TX) or just a receiver (RX). The Bluetooth module 2432, the WLAN module 2434, the SPS module 2436, and the cellular module 2438 may each include dedicated antennas and/or utilize antennas 2440 for communication with one or more other nodes. For example, the UE apparatus 2402 can communicate through the transceiver(s) 2430 via the antennas 2440 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 2426 and the application processor 2406 may each include a computer-readable medium/memory 2426′, 2406′, respectively. The additional module of memory 2416 may also be considered a computer-readable medium/memory. Each computer-readable medium/memory 2426′, 2406′, 2416 may be non-transitory. The wireless baseband processor 2426 and the application processor 2406 may each be responsible for general processing, including execution of software stored on the computer-readable medium/memory 2426′, 2406′, 2416. The software, when executed by the wireless baseband processor 2426/application processor 2406, causes the wireless baseband processor 2426/application processor 2406 to perform the various functions described herein. The computer-readable medium/memory may also be used for storing data that is manipulated by the wireless baseband processor 2426/application processor 2406 when executing the software. The wireless baseband processor 2426/application processor 2406 may be a component of the UE 102. The UE apparatus 2402 may be a processor chip (e.g., modem and/or application) and include just the wireless baseband processor 2426 and/or the application processor 2406. In other examples, the UE apparatus 2402 may be the entire UE 102 and include the additional modules of the apparatus 2402.

As discussed in FIG. 1 and implemented with respect to the methods of FIGS. 8, 14, and 17, the action time component 140 is configured to perform the aspects described herein. The action time component 140 may be within the application processor 2406 (e.g., at 140a), the wireless baseband processor 2426 (e.g., at 140b), or both the application processor 2406 and the wireless baseband processor 2426. The action time component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 25 is a diagram 2500 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 2546, which may have on-chip memory 2546′. In some aspects, the CU 110 may further include an additional module of memory 2556 and/or a communications interface 2548, both of which may be coupled to the CU processor 2546. The CU 110 can communicate with the DU 108 through a midhaul link 162, such as an F1 interface between the communications interface 2548 of the CU 110 and a communications interface 2528 of the DU 108.

The DU 108 may include a DU processor 2526, which may have on-chip memory 2526′. In some aspects, the DU 108 may further include an additional module of memory 2536 and/or the communications interface 2528, both of which may be coupled to the DU processor 2526. The DU 108 can communicate with the RU 106 through a fronthaul link 160 between the communications interface 2528 of the DU 108 and a communications interface 2508 of the RU 106.

The RU 106 may include an RU processor 2506, which may have on-chip memory 2506′. In some aspects, the RU 106 may further include an additional module of memory 2516, the communications interface 2508, and one or more transceivers 2530, all of which may be coupled to the RU processor 2506. The RU 106 may further include antennas 2540, which may be coupled to the one or more transceivers 2530, such that the RU 106 can communicate through the one or more transceivers 2530 via the antennas 2540 with the UE 102.

The on-chip memory 2506′, 2526′, 2546′ and the additional modules of memory 2516, 2536, 2556 may each be considered a computer-readable medium/memory. Each computer-readable medium/memory may be non-transitory. Each of the processors 2506, 2526, 2546 is responsible for general processing, including execution of software stored on the computer-readable medium/memory. The software, when executed by the corresponding processor(s) 2506, 2526, 2546 causes the processor(s) 2506, 2526, 2546 to perform the various functions described herein. The computer-readable medium/memory may also be used for storing data that is manipulated by the processor(s) 2506, 2526, 2546 when executing the software. In examples, the configuration component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to the method of FIGS. 9, 15, and 18, the configuration component 150 is configured to perform the aspects described herein. The configuration component 150 may be within one or more processors of the one or more network entities 104, such as the RU processor 2506 (e.g., at 150a), the DU processor 2526 (e.g., at 150b), and/or the CU processor 2546 (e.g., at 150c). The configuration component 150a-150c may be one or more hardware components specifically configured to carry out the stated processes/algorithm, implemented by one or more processors 2506, 2526, 2546 configured to perform the stated processes/algorithm, stored within a computer-readable medium for implementation by the one or more processors 2506, 2526, 2546, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, on a PDSCH from a network entity, an activation indication that activates a subset of TCI states from a list of TCI states; transmitting, to the network entity, an acknowledgement (ACK) for the PDSCH on a multi-slot physical uplink shared channel (PUSCH); and communicating with the network entity based on an action time associated with the activated subset of TCI states.

Example 2 may be combined with Example 1 and further includes receiving, from the network entity, a configuration for the list of TCI states and the action time associated with the activated subset of TCI states.

Example 3 may be combined with any of Examples 1-2 and further includes applying the activated subset of TCI states at the action time or after the action time.

Example 4 may be combined with any of Examples 1-3 and further includes transmitting, to the network entity, a UE capability report indicating a UE capability of the UE for PUSCH-based ACK/NACK feedback for TCI activation.

Example 5 may be combined with any of Examples 1-4 and includes that the action time is based on a TCI activation delay from a last symbol of the multi-slot PUSCH.

Example 6 may be combined with any of Examples 1-4 and includes that the action time is based on a TCI activation delay from a last symbol of a PUSCH transmission occasion that includes the ACK for the PDSCH.

Example 7 may be combined with any of Examples 1-4 and includes that the activation indication is a MAC-CE that indicates the action time is based on a TCI activation delay from a last symbol of the multi-slot PUSCH or a last symbol of a PUSCH transmission occasion associated with the ACK for the PDSCH.

Example 8 may be combined with any of Examples 2-4 and includes that the configuration indicates that the action time is based on a TCI activation delay from a last symbol of the multi-slot PUSCH or a last symbol of a PUSCH transmission occasion associated with the ACK for the PDSCH.

Example 9 is a method of wireless communication at a network entity, including: transmitting, on a PDSCH to a UE, an activation indication that activates a subset of TCI states from a list of TCI states; receiving, from the UE, an ACK for the PDSCH, the PDSCH being associated with a multi-slot PUSCH; and communicating with the network entity based on an action time associated with the activated subset of TCI states.

Example 10 may be combined with Example 9 and further includes transmitting, to the UE, a configuration for the list of TCI states and the action time associated with the activated subset of TCI states.

Example 11 may be combined with any of Examples 9-10 and further includes applying the activated subset of TCI states at the action time or after the action time.

Example 12 may be combined with any of Examples 9-11 and further includes receiving, from the UE, a UE capability report indicating a UE capability of the UE for PUSCH-based ACK/NACK feedback for TCI activation.

Example 13 is a method of wireless communication at a UE, including: receiving, on a PDSCH from a network entity, an activation indication that activates a subset of TCI states from a list of TCI states; receiving, from the network entity, a TCI indication that indicates one or more TCI states from the subset of TCI states; transmitting, to the network entity, an ACK for the TCI indication; and communicating with the network entity after an action time associated with the one or more TCI states based on the TCI indication for the one or more TCI states.

Example 14 may be combined with Examples 13 and includes that the action time is based on at least one of a first action delay or a second action delay, the first action delay being associated with a beam indication through DCI, the second action delay being associated with the TCI indication being indicated through the DCI.

Example 15 may be combined with Example 14 and further includes transmitting, to the network entity, a UE capability indicating at least one of: whether the UE supports the second action delay, a supported minimum value of the second action delay, or a supported maximum value of the second action delay.

Example 16 may be combined with any of Examples 14-15 and includes that the action time is based on a sum of the first action delay and the second action delay, a maximum action delay of the first action delay and the second action delay, or a minimum action delay of the first action delay and the second action delay.

Example 17 is a method of wireless communication at a network entity, including: transmitting, on a PDSCH to a UE, an activation indication that activates a subset of TCI states from a list of TCI states; transmitting, to the UE, a TCI indication that indicates one or more TCI states from the subset of TCI states; receiving, from the UE, an ACK for the TCI indication; and communicating with the UE after an action time associated with the one or more TCI states based on the TCI indication for the one or more TCI states.

Example 18 is a method of wireless communication at a UE, including: receiving, from a network entity, control signaling scheduling a multi-slot channel transmission, an action time for a number of TCI states being within the multi-slot channel transmission; transmitting, to the network entity, an ACK for the control signaling that schedules the multi-slot channel transmission; and communicating with the network entity through the multi-slot channel transmission based on one or more applied TCI states from the number of TCI states and a transmission scheme for the multi-slot channel transmission.

Example 19 may be combined with Example 18 and includes that the multi-slot channel transmission includes a multi-slot PUSCH transmission, a multi-slot PUCCH transmission, or a multi-slot PDSCH transmission.

Example 20 may be combined with any of Examples 18-19 and further includes transmitting, to the network entity, a UE capability report indicating a UE capability of the UE for communicating with the network entity based on a change to the number of TCI states and the action time for the number of TCI states within the multi-slot channel transmission.

Example 21 may be combined with any of Examples 18-20 and includes that the one or more applied TCI states and the transmission scheme for the multi-slot channel transmission includes: for each slot of the multi-slot channel transmission, determining the transmission scheme and an applied TCI state, wherein the transmission scheme is associated with an sTRP or an mTRPs.

Example 22 is a method of wireless communication at a network entity, including: transmitting, to a UE, control signaling scheduling a multi-slot channel transmission, an action time for a number of TCI states being within the multi-slot channel transmission; receiving, from the UE, an ACK for the control signaling that schedules the multi-slot channel transmission; and communicating with the UE through the multi-slot channel transmission based on one or more applied TCI states from the number of TCI states and a transmission scheme for the multi-slot channel transmission.

Example 23 is an apparatus for wireless communication for implementing a method as in any of Examples 1-22.

Example 24 is an apparatus for wireless communication including means for implementing a method as in any of Examples 1-22.

Example 25 is a non-transitory computer-readable medium storing computer executable code, the code when executed by a processor causes the processor to implement a method as in any of Examples 1-22.

What is claimed is:

1. A method of wireless communication at a user equipment (UE), comprising:
receiving, from a network entity, on a physical downlink shared channel (PDSCH), a medium access control-control element (MAC-CE) that activates a subset of transmission configuration indicator (TCI) states from a list of TCI states;
transmitting, to the network entity, an acknowledgement (ACK) for the PDSCH on a multi-slot physical uplink shared channel (PUSCH); and
communicating with the network entity based on an action time associated with the activated subset of TCI states.

2. The method of claim 1, wherein the multi-slot PUSCH comprises a plurality of PUSCH transmission occasions in a plurality of slots, and wherein the transmitting comprises transmitting on one or more PUSCH transmission occasions in each slot of the plurality of slots, the method further comprising:
receiving, from the network entity, a radio resource control (RRC) signaling configuring the list of TCI states and the action time associated with the activated subset of TCI states.

3. The method of claim 1, further comprising:
applying the activated subset of TCI states at the action time or after the action time.

4. The method of claim 1, further comprising:
transmitting, to the network entity, a UE capability report indicating a UE capability of the UE for PUSCH-based acknowledgment/negative-acknowledgment (ACK/NACK) feedback for TCI activation.

5. The method of claim 1, wherein the action time is based on a TCI activation delay from a last symbol of the multi-slot PUSCH.

6. The method of claim 5, wherein the UE applies the activated subset of TCI states from a first slot that is a time duration of the TCI activation delay after the last symbol of the multi-slot PUSCH with the ACK.

7. The method of claim 1, wherein the action time is based on a TCI activation delay from a last symbol of a PUSCH transmission occasion that includes the ACK for the PDSCH.

8. The method of claim 1, wherein the MAC-CE indicates the action time is based on a TCI activation delay from a last symbol of the multi-slot PUSCH or a last symbol of a PUSCH transmission occasion that includes the ACK for the PDSCH.

9. The method of claim 2, wherein the RRC signaling indicates that the action time is based on a TCI activation delay from a last symbol of the multi-slot PUSCH or a last symbol of a PUSCH transmission occasion that includes the ACK for the PDSCH.

10. A method of wireless communication at a network entity, comprising:
transmitting, to a user equipment (UE), on a physical downlink shared channel (PDSCH), a medium access control-control element (MAC-CE) that activates a subset of transmission configuration indication (TCI) states from a list of TCI states;
receiving, from the UE, an acknowledgement (ACK) for the PDSCH on a multi-slot physical uplink shared channel (PUSCH); and
communicating with the UE based on an action time associated with the activated subset of TCI states.

11. The method of claim 10, wherein the multi-slot PUSCH comprises a plurality of PUSCH transmission occasions in a plurality of slots, and wherein the receiving comprises receiving on one or more PUSCH transmission occasions in each slot of the plurality of slots, the method further comprising:
transmitting, to the UE, a radio resource control (RRC) signaling configuring the list of TCI states and the action time associated with the activated subset of TCI states.

12-14. (canceled)

15. The method of claim 10, wherein the activated subset of TCI states is applied from a first slot that is a time duration of a TCI activation delay after a last symbol of the multi-slot PUSCH with the ACK.

16. (canceled)

17. The method of claim 10, wherein the MAC-CE indicates the action time is based on a TCI activation delay from a last symbol of the multi-slot PUSCH or a last symbol of a PUSCH transmission occasion that includes the ACK for the PDSCH.

18. The method of claim 11, wherein the RRC signaling indicates that the action time is based on a TCI activation delay from a last symbol of the multi-slot PUSCH or a last symbol of a PUSCH transmission occasion that includes the ACK for the PDSCH.

19. An apparatus for wireless communication at a user equipment (UE), comprising: a transceiver;
a processor; and
a memory coupled to the processor to store instructions, which when executed by the processor, cause the processor to:
receive, from a network entity, on a physical downlink shared channel (PDSCH), a medium access control-control element (MAC-CE) that activates a subset of transmission configuration indicator (TCI) states from a list of TCI states;
transmit, to the network entity, an acknowledgement (ACK) for the PDSCH on a multi-slot physical uplink shared channel (PUSCH); and
communicate with the network entity based on an action time associated with the activated subset of TCI states.

20. The apparatus of claim 19, wherein the multi-slot PUSCH comprises a plurality of PUSCH transmission occasions in a plurality of slots, and wherein the transmitting comprises transmitting on one or more PUSCH transmission occasions in each slot of the plurality of slots, wherein the processor is further caused to:
receive, from the network entity, a radio resource control (RRC) signaling configuring the list of TCI states and the action time associated with the activated subset of TCI states.

21. The apparatus of claim 19, wherein the processor is further caused to:
transmit, to the network entity, a UE capability report indicating a UE capability of the UE for PUSCH-based acknowledgment/negative-acknowledgment (ACK/NACK) feedback for TCI activation.

22. The apparatus of claim 19, wherein the activated subset of TCI states is applied from a first slot that is a time duration of the TCI activation delay after the last symbol of the multi-slot PUSCH with the ACK.

23. The apparatus of claim 19, wherein the MAC-CE indicates the action time is based on a TCI activation delay from a last symbol of the multi-slot PUSCH or a last symbol of a PUSCH transmission occasion that includes the ACK for the PDSCH.

24. The apparatus of claim 20, wherein the RRC signaling indicates that the action time is based on a TCI activation delay from a last symbol of the multi-slot PUSCH or a last symbol of a PUSCH transmission occasion that includes the ACK for the PDSCH.
